(19) United States
(12) Patent Application Publication
(10) Pub. No.: US 2026/0335805 A1
(43) Pub. Date: Oct. 29, 2026

(54) FILTER ELEMENT AND FILTER DEVICE

(71) Applicant: MANN+HUMMEL GmbH, Ludwigsburg (DE)

(72) Inventors: Maximilian BAUCH, Freudental (DE); Kevin KOHN, Großbottwar (DE); Sven EPLI, Heilbronn (DE)

(21) Appl. No.: 19/706,105

(22) Filed: Jun. 12, 2026

Related U.S. Application Data
(63) Continuation of application No. PCT/EP2024/083017, filed on Nov. 20, 2024.

(30) Foreign Application Priority Data
Dec. 13, 2023 (DE) 10 2023 134 990.2

(51) Int. Cl. B01D 46/24; B01D 46/52

(52) U.S. Cl. CPC B01D 46/2403; B01D 46/521; B01D 2271/02; B01D 2279/60

(57) ABSTRACT

A filter element for filtering fluid has a filter medium body to permit flow therethrough by fluid to be purified in flow direction from an upstream side to a downstream side. A seal device at the filter medium body has a circumferentially extending sealing surface which, in at least one circumferential section, has a first undulated course in circumferential direction of the sealing surface. The undulated course has a period and/or an amplitude variable in circumferential direction. A filter device has a filter housing with fluid inlet, fluid outlet, and a receiving space in which the filter element is arranged such that a raw side is separated from a clean side. The sealing surface of the filter element rests against a circumferential housing sealing surface of the filter housing that has a second undulated course corresponding to the first undulated course of the sealing surface of the filter element.

### CROSS-REFERENCE TO RELATED APPLICATIONS

This application is a continuation application of international application No. PCT/EP2024/083017 having an international filing date of Nov. 20, 2024, and designating the United States, the international application claiming a priority date of Dec. 13, 2023, based on prior filed German patent application No. 10 2023 134 990.2, the entire contents of the aforesaid applications being incorporated herein by reference to the fullest extent permissible.

### BACKGROUND

One aspect of the present application concerns a filter element for filtering a fluid, for example an air filter element for an air filter system, for example for an intake air filter system of a fuel cell or internal combustion engine. Furthermore, another aspect of the application concerns a filter device with such a filter element.

The intake air of fuel cells and/or internal combustion engines is usually purified by means of an air filter from particulate and/or gaseous contaminants prior to entering a cathode chamber or internal combustion chamber, for which purpose air filter elements are used. Furthermore, the air that is flowing into a vehicle cabin is also freed as completely as possible from contaminants. Possibly occurring impurities are fine dust, pollen, soot or aerosols, for example.

In general, a filter element or a filter insert is understood to be device components which are arrangeable in a filter housing and exchangeable as a unit and which comprise at least one filter medium body of a filter medium, often in the form of a folded filter bellows, and usually also a structure carrying or supporting the filter medium and, most of the time, a seal. The respective filter medium comprises usually a limited service life for which reason filter elements must be regularly exchanged.

Such filter elements or filter inserts are configured frequently as so-called round elements which comprise a filter bellows arranged around a longitudinal axis and enclosing an interior at least partially. The filter bellows may be delimited by an open end disc at a first end face and by a further end disc, for example a closed end disc, at a second end positioned opposite the first end face. A circumferential seal is usually arranged at the open end disc.

As an alternative, such filter elements or filter inserts may also be realized as so-called flat elements which, in general, comprise a prism-shaped, for example cuboid, filter bellows. The filter bellows may permit flow therethrough, in this context along a longitudinal axis, by a liquid and comprise a circumferentially extending seal which is arranged around an outer circumference of the filter bellows.

For various reasons, it may be technically required in this context that filter elements or filter inserts are inserted in a predetermined installation position in a filter housing. For example, in the above mentioned applications, volume and/or mass flow sensors are often employed which measure an intake air quantity. Such volume and/or mass flow sensors are generally calibrated in regard to a predetermined installation position of the filter element or filter insert so that measuring imprecisions occur in case of an installation of the filter element or filter insert in the filter housing which deviates from the predetermined installation position. In case of round elements, the reason for this is that the filter bellows, in general, have a seam site which affects an outflow-side flow profile.

EP 3 370 849 A1 discloses a filter element with a filter medium body which may permit flow therethrough, for example along a longitudinal axis. On a wall surface of the filter medium body, a sealing element is attached which comprises at least one sealing surface that, viewed across the circumference, has a regular undulated course. An axial distance of the sealing surface from an inflow or outflow surface of the filter medium body varies across the circumference due to the undulated shape.

Moreover, EP 3 441 124 A1 discloses a filter element with a filter medium body which may be radially flowed through and is axially delimited at the end by a respective end disc. One of the end discs is an open end disc which comprises an opening which is in fluid communication with an interior enclosed by the filter medium body. At the open end disc, a circumferential seal structure is present which surrounds the opening. The circumferential seal structure has a regular undulated crown shape and rises along the longitudinal axis from the open end disc.

A disadvantage of this prior art is that, as a result of the regular undulated shape, no unequivocal installation position in a filter housing may be defined.

### SUMMARY

In view of this background, the embodiments described herein have the object to provide a filter element that makes it possible, better than before, to enforce an unequivocal installation position in a filter housing.

This object can be solved by a filter element for filtering a fluid, for example air filter element for an air filter system, such as an intake air filter system of a fuel cell or internal combustion engine, comprising:
at least one filter medium body with at least one filter medium, which may permit flow therethrough by a fluid to be purified in a flow direction from an upstream side to a downstream side, and at least one seal device arranged at the filter medium body,
wherein the seal device comprises at least one circumferentially extending sealing surface,
and wherein the sealing surface of the seal device comprises an undulated course in at least one circumferential section,
wherein the undulated course comprises a variable period and/or amplitude in circumferential direction.

This object can be further solved by a filter device comprising a filter housing with a fluid inlet and a fluid outlet as well as a receiving space for a filter element in which a filter element is arranged such that it separates a raw side correlated with the fluid inlet from a clean side correlated with the fluid outlet, wherein the filter element is a filter element according to the embodiments described herein.

Further embodiments are subject matter of the dependent claims as well as other embodiments described herein.

One aspect of the embodiment disclosed herein concerns a filter element which is configured for filtering of fluid, for example an air filter element for an air filter system, such as an intake air filter system of a fuel cell or internal combustion engine. However, it is in principle also possible that the embodiments of filter elements described herein may be a liquid filter element, for example, for filtration of oil, fuels, or water or aqueous solutions.

The filter element according to some embodiments comprises at least one filter medium body with at least one filter medium, which may permit flow therethrough by a fluid to be purified in a flow direction from an upstream side to a downstream side, and at least one seal device arranged at the filter medium body. The seal device comprises at least one circumferentially extending sealing surface which, in at least one circumferential section, comprises an undulated course which comprises a variable period and/or amplitude in circumferential direction.

The term “filter medium body” comprises in its broadest meaning any bodies that comprise at least one filter medium which may be present in a form that is folded or not folded. The filter medium may be for example a particle filter medium or a gas filter medium. Optionally, the filter medium may comprise at least one adsorbent, such as an active carbon. A filter medium embodied as a particle filter medium may comprise for example a nonwoven material, such as synthetic fibers and/or cellulose fibers.

An undulated shape with variable period and/or amplitude in circumferential direction signifies a technically simple possibility for the sealing surface to provide a defined installation orientation for the filter element.

The circumferential section of the sealing surface with the undulated course with variable period and/or amplitude in circumferential direction may comprise for example a rotation-asymmetrical structure so that a mandatory angular orientation of the filter element in relation to a filter housing is enabled which significantly reduces the possibilities of inserting the filter element improperly in a filter housing in deviation from its predetermined angular position.

In some embodiments, the circumferentially extending sealing surface may comprise an undulated course across its entire circumference, such as where the period and/or amplitude is variable across the entire circumference. In other embodiments, the circumferentially extending sealing surface may have an undulated course with variable period and/or amplitude in circumferential direction only across a portion of its circumference and may have a planar course in other circumferential sections.

For example, the undulated course may be configured to be transverse wave undulated. As an alternative or in addition, the undulated course may comprise a sine wave undulated course, a rectangular wave undulated course, a triangular wave undulated course, a sawtooth wave undulated course, or a course formed by a spline curve.

In relation to the longitudinal axis, a course of a transverse wave undulated configuration of the sealing surface may have an expansion direction in circumferential direction and an “oscillation direction” in radial direction and/or in axial direction. In this way, a sealing surface may be formed with an undulated course which across the circumference has a changing axial and/or radial position. It is explicitly possible that the undulated course is formed by a superposition of at least two transverse waves. A first transverse wave may comprise in this context an oscillation direction in radial direction and a second transverse wave an oscillation direction in axial direction.

A sine wave undulated course of the seal surface with a variable period and/or amplitude in circumferential direction may be described by the following general functional equation:

f(x)=α·sin(b·x^{c})·D(x)
wherein
X is a circumferential coordinate,
a is a constant modifying the amplitude,
b is a constant modifying the period,
C is a constant modifying a variability of the period across the circumference, and
D(x) is a function of the circumferential coordinate, for example, a polynomial, a hyperbole function, a logarithm function, which modifies a variability of the amplitude across the circumference.

In case of an undulated course of the sealing surface with a variable period (and constant amplitude) in circumferential direction, D(x) may be a constant. In case of an undulated course of the sealing surface with a variable amplitude (and constant period) in circumferential direction, it is possible that c=1.

In some embodiments, the term x^{c} may be replaced by another term which enables a modification of the variability of the period across the circumference.

Depending on whether an undulated course with “oscillation direction” in radial direction and/or in axial direction is to be described by means of the aforementioned general functional equation, f(x) may describe an axial coordinate (parallel to the longitudinal axis) or a radial coordinate (perpendicular to the longitudinal axis). The circumferential coordinate x, depending on the application situation, may be expressed in Cartesian or in polar coordinates. In this context, a representation in polar coordinates makes it possible particularly easily to illustrate the undulated course as a deviation from an ideal circular shape.

In order to describe the undulated course of the sealing surface with a variable period and/or amplitude in a circumferential direction based on a predetermined basic shape of a circumferential seal line defined by the sealing surface, the aforementioned general functional equation may be overlaid with a term describing the basic shape. For example, the predetermined basic shape may be a circular shape. However, other basic shapes are also possible such as, for example, an oval, flat oval, or rectangular shape.

According to a further embodiment, the filter medium body may be arranged around a longitudinal axis and enclose an interior at least partially. For example, the filter medium body may permit flow therethrough in this context in radial direction in relation to the longitudinal axis.

For example, the filter medium body may surround the interior completely circumferentially, wherein circumferential ends which are initially free when manufactured (in case of folded filter bellows, the so-called end folds) may be connected to each other in order to form a circumferentially “endless” filter medium body. In some embodiments, it is however also possible that, between the circumferential ends initially free when manufactured, an adapter part may be arranged which connects the initially free circumferential ends to each other.

The filter medium body may permit flow therethrough, for example in a radial direction, such as from the exterior to the interior in radial direction, so that a clean side may be present for example in the region of the interior enclosed by the filter medium body. In other embodiments, a fluid may flow from the interior to the exterior in radial direction so that a raw side may be present in the region of the interior enclosed by the filter medium body.

According to a yet another embodiment, a fluid-permeable support grid may be arranged in the interior, such as in the case where the support grid for example supports the filter medium body at an inner wall surface that adjoins the interior. The support grid may be designed for example as a support tube that comprises a plurality of openings. The support tube may comprise a plurality of stays which extend in circumferential direction and/or longitudinal direction, wherein the filter medium body may be supported by its inner wall surface at the stays.

In a further embodiment, the filter medium body may have a first end face and a second end face oppositely positioned thereto along the longitudinal axis. The filter element may comprise an end disc that is open toward the interior at the first end of the filter medium body and a further end disc, such as a closed end disc, at the oppositely positioned second end of the filter medium body. In this context, the seal device may be arranged at the end disc open toward the interior.

Here, “first end” and “second end” refer for example to ends of the filter medium body which are facing away from each other in relation to the longitudinal axis.

In embodiments, the end disc open toward the interior may comprise or be comprised of a plastic material, for example a foamed plastic material, such as a polyurethane foam. For example, the seal device with the at least one circumferentially extending sealing surface may be one piece together with the end disc that is open toward the interior. The end disc that is open toward the interior may be connected to the first end of the filter bellows, for example connected by material fusion, such as welded on, glued on or foamed on.

In some embodiments, the seal device with the at least circumferentially extending sealing surface may be produced together with the end disc open toward the interior by a casting process by using a foamable and flowable plastic material so that providing the undulation incurs no additional expenditure in regard to the manufacture.

In a further embodiment, a support grid arranged in the interior may comprise, at an end which is close to the first end of the filter bellows, an end face section which may be embedded in a material of the end disc open toward the interior.

According to a further embodiment, the seal device may comprise a circumferential seal profile which rises in direction of the longitudinal axis from the end disc that is open toward the interior and which comprises the circumferentially extending sealing surface.

According to yet another embodiment, the circumferentially extending seal profile may be one piece together with the end disc that is open toward the interior, such as where the end disc is open toward the interior and integrally formed together with the circumferential seal profile on the filter medium body, such as foamed on, cast on, welded on, or glued on.

In alternative embodiments, the seal device may also be arranged at a position deviating from that of the end disc, for example, at the wall surface of the filter medium body. In this context, the seal device may be present, for example at an axial position which is closer to the end disc that is open toward the interior than a closed end disc. Furthermore, the seal device may comprise an at least partially circumferential seal carrier which carries a circumferential seal profile providing the at least one sealing surface.

In embodiments, the filter medium body may comprise a hollow cylindrical shape, such as with a circular, elliptical, oval, elongate oval and/or kidney-shaped cross-sectional shape.

As an alternative or in addition, the filter bellows may also expand in a direction of the longitudinal axis from the first end toward the second end or in reverse so that, for example, an overall conical shape results.

According to a further embodiment, the filter medium body, in at least one circumferential section at the first end, may comprise an undulated course in relation to an axial direction defined by the longitudinal axis which comprises a variable period and/or amplitude in circumferential direction and corresponds to the undulated course of the circumferentially extending sealing surface. The undulated course of the filter medium body at the first end may be formed for example by axial cutting of the filter medium body. In this context, the end disc open toward the interior may follow the undulated course of the filter medium body at the first end. When the filter medium body is a filter bellows of folded filter medium, the cutting may be carried out already prior to folding in a flat state of the filter medium, for example, by means of a laser cutting device.

As an alternative, the first end of the filter medium body may lie in a plane. For example, the first end may lie in a perpendicular plane in relation to the longitudinal axis or may extend at an acute angle in relation to the perpendicular plane. In this context, a section, which extends axially at least partially circumferentially between the first end of the filter medium body and the circumferentially extending sealing surface, may be bridged by at least one partially circumferential flow guiding body. For example, the flow guiding body is configured completely circumferentially. The flow guiding body may be indirectly or directly connected to the first end of the filter medium body.

The flow guiding body may be a plastic component. The flow guiding body may be configured separate from the end disc that is open toward the interior. As an alternative, the flow guiding body may also be formed by a flow guiding section of the end disc open toward the interior and for example may be configured as one piece together with the latter.

According to yet another embodiment, the filter medium body may comprise a round filter bellows of a filter medium with a plurality of folds whose radially outer fold edges are lying in an outer wall surface and whose radially inner fold edges are lying in an inner wall surface. The inner wall surface adjoins the interior.

The round filter bellows may comprise, for example, a closed cross section.

The folds of the round filter bellows may be present for example in the form of a star folding, wherein the folds, for example across a major portion of the circumference, have a uniform cross-sectional shape. The plurality of folds may be present as V folds with uniform fold heights across the circumference. As an alternative, the plurality of folds may also be present as so-called W folds or M folds with intermediate folds of a reduced fold height.

In embodiments, the circumferentially extending sealing surface may comprise at least one circumferential radial sealing surface which is present for example at an inner circumference of the circumferential seal profile.

However, the circumferential seal profile may also comprise more than two radial sealing surfaces, for example, a first radial sealing surface at the inner circumference and a second radial sealing surface at the outer circumference. As an alternative or in addition, it is possible that the circumferential seal profile comprises at least one axial sealing surface, for example at an end face of the circumferential seal profile. The seal profile may comprise a predetermined cross section that may comprise one or a plurality of sealing strands, for example extending parallel to each other. The embodiments disclosed herein however are explicitly not limited to a certain direction of action of the sealing action and/or certain seal profiles. Instead, all seal profiles which appear suitable to a person of skill in the art may be used.

According to an alternative further development, the upstream side and the downstream side of the filter medium body may be spaced apart from each other along the longitudinal axis and the filter medium body may permit flow therethrough along the longitudinal axis. The seal device in this context may be arranged at or adjacent to an outer circumference of the filter medium body.

The filter medium body may comprise for example a flat filter bellows of a filter medium with a plurality of folds whose inflow-side fold edges are present at the upstream side, for example in an inflow plane, and whose outflow-side fold edges are present at the downstream side, for example in an outflow plane.

The filter medium body may comprise for example the shape of a prism, for example of a straight prism, for example wherein the filter medium body at least in sections is configured in a cuboid shape.

According to a further embodiment, the filter element may comprise a frame device which frames the filter medium body at its outer circumference at least partially circumferentially. The seal device may be arranged in this context at a side face of the frame device which is facing away from the filter medium body, for example wherein the seal device protrudes radially past the frame device.

The frame device may comprise a frame element which completely frames the filter medium body. The frame element may comprise or be comprised of a plastic material, which for example may be glued or molded onto the filter medium body. As an alternative or in addition, the frame element may be formed of a textile material, for example, a spunbond nonwoven, and may comprise at least one so-called lateral band at the end face edges of a folded filter medium body as well as at least one so-called head band at the end folds of a folded filter medium body. The frame device functions as a mechanical carrier structure for the seal device.

According to yet another embodiment, it is possible that the seal device is arranged directly at the filter medium body in the region of a circumferential outer edge of the filter medium body, for example at the upstream or downstream side of the filter medium body. For example, the seal device may comprise in this context a plastic material, for example a foamed plastic material, such as a polyurethane foam. The seal device may be formed for example directly on a circumferential outer edge of the filter medium body, for example at the upstream or downstream side, for example foamed on. In this context, the seal device—viewed in cross section—may comprise an axial connection leg extending along a wall surface of the filter medium body and/or a radial connection leg extending along an inflow plane or outflow plane of the filter medium body in order to achieve a mechanically loadable connection of the seal device to the filter medium body.

In embodiments, the circumferentially extending sealing surface in the at least one circumferential section with an undulated course may comprise a changing axial distance in circumferential direction in relation to a reference plane which is extending in a perpendicular direction in relation to the longitudinal axis. The reference plane for example may coincide with the end disc open toward the interior, the first end of the filter medium body and/or with an inflow plane or outflow plane.

As an alternative or in addition, the circumferentially extending sealing surface in the at least one circumferential section with an undulated course may comprise a changing radial distance in circumferential direction in relation to a surface which envelops the filter medium body. The surface enveloping the filter medium body may be for example a wall surface of the filter medium body.

As an alternative or in addition, the circumferentially extending sealing surface in the at least one circumferential section with an undulated course may comprise a changing radial distance in circumferential direction in relation to the longitudinal axis.

The seal device with the at least one circumferential section with an undulated course of the sealing surface may be configured, for example, to be rotation-asymmetrical.

The undulated course of the sealing surface may comprise at least two wave troughs and/or wave peaks, for example at least three wave troughs and/or wave peaks, for example at least four wave troughs and/or wave peaks. In case of a period of the undulated course variable in circumferential direction, wave troughs and/or wave peaks adjoining a wave trough or a wave peak each comprise different distances. In case of a variable amplitude of the undulated course in circumferential direction, wave troughs and/or wave peaks adjoining a wave trough or a wave peak each comprise different deflections (maxima and/or minima).

Another aspect of the embodiments disclosed herein concerns a filter device comprising a filter housing with a fluid inlet and a fluid outlet as well as with a receiving space for a filter element, in which a filter element according to any of the above-described embodiments is arranged such that it separates a raw side correlated with the fluid inlet from a clean side correlated with the fluid outlet.

The filter device may be for example an air filter device, for example an intake air filter device of a fuel cell or internal combustion engine or a cabin air filter device. The filter housing may be for example an air filter housing.

For example, the filter housing comprises at least one circumferential housing sealing surface at which the circumferentially extending sealing surface of the filter element is resting, wherein the housing sealing surface, in at least one circumferential section, comprises an undulated course with variable period and/or amplitude in circumferential direction which corresponds to the undulated course of the sealing surface of the filter element.

The filter housing may be for example of a two-part configuration and comprise a housing pot in which the receiving space is present as well as a housing cover detachably connected or connectable to the housing pot. The housing sealing surface may be present in this context either at the housing pot or at the housing cover.

The interaction between the housing sealing surface and the sealing surface of the filter element represents in this context the functional main interface between the filter housing and the filter element. Its main function, namely sealing the raw side from the clean side, may be fulfilled by the main interface only when the housing sealing surface matches the structure of the sealing surface of the filter element, wherein for example the housing sealing surface at least in sections may have the configuration of a counterpart shape of the sealing surface of the filter element.

Since in embodiments the housing sealing surface as well as the sealing surface of the filter element are not rotation-symmetrical in relation to the longitudinal axis, a predetermined installation position of the filter element in the filter housing in relation to the longitudinal axis may be reliably enforced by an interaction of filter element and filter housing at the main interface.

It is understood that features, feature combinations as well as their specific advantages disclosed in relation to the filter elements disclosed herein may be applied to the filter devices disclosed herein, and vice versa.

Further possible implementations of the embodiments disclosed herein comprise also not explicitly mentioned combinations of features disclosed above or in the following in regard to the embodiments. In this context, a person of skill in the art will also add individual aspects as improvements or supplements to the respective basic form of the embodiments disclosed herein.

### BRIEF DESCRIPTION OF THE DRAWINGS

In the following, the disclosed subject matter will be explained in more detail with the aid of embodiments with reference to the attached drawing figures.

FIG. 1 shows an isometric view of a filter element according to a first embodiment.

FIG. 2 shows a longitudinal section of the filter element according to the first embodiment.

FIG. 3 shows a plan view of the filter element according to the first embodiment from the side of the open end disc.

FIG. 4 shows a schematic illustration of an axial distance of the circumferentially extending sealing surface in relation to a reference plane across the circumference which comprises an undulated course.

FIG. 5 shows an isometric view of a filter element according to a second embodiment.

FIG. 6 shows a longitudinal section of the filter element according to the second embodiment.

FIG. 7 shows an isometric view of a filter element according to a third embodiment.

FIG. 8 shows a longitudinal section of the filter element according to the third embodiment.

FIG. 9 shows an isometric view of a filter element according to a fourth embodiment.

FIG. 10 shows a longitudinal section of the filter element according to the fourth embodiment.

FIG. 11 shows an isometric view of a filter element according to a fifth embodiment.

FIG. 12 shows a longitudinal section of the filter element according to the fifth embodiment.

FIG. 13 shows a plan view of the filter element according to the fifth embodiment from the side of the open end disc.

FIG. 14 shows an isometric view of a filter element according to a sixth embodiment.

FIG. 15 shows a longitudinal section of the filter element according to the sixth embodiment.

FIG. 16 shows an isometric view of a filter element according to a seventh embodiment.

FIG. 17 shows projection views of the filter element according to the seventh embodiment.

FIG. 18 shows an example of an undulated course with radial “oscillation direction”.

FIG. 19 shows a further example of an undulated course with radial “oscillation direction”.

FIG. 20 shows yet another example of an undulated course with radial “oscillation direction”.

### DETAILED DESCRIPTION

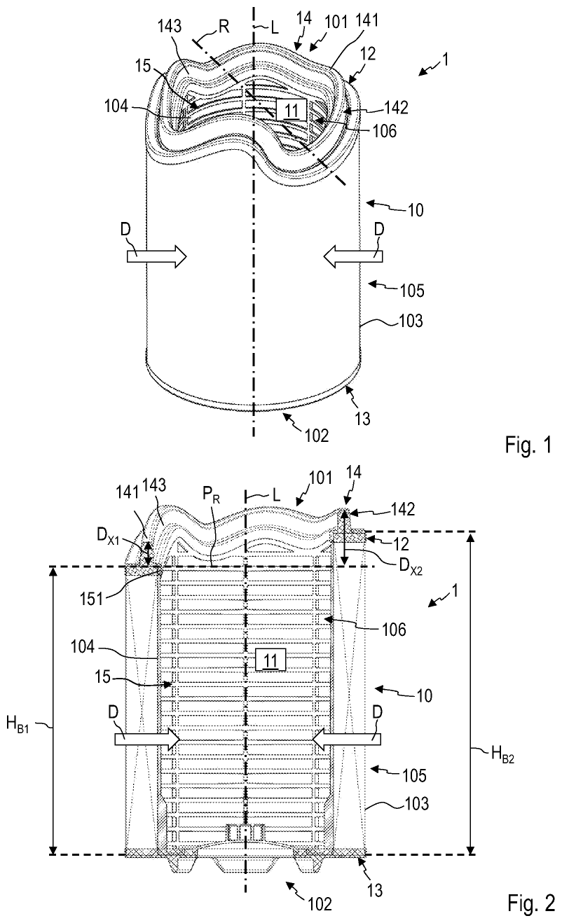

FIG. 1 shows a filter element 1 for filtering a fluid, for example an air filter element for an air filter system, for example for an intake air filter system of a fuel cell or internal combustion engine, according to a first embodiment. The filter element is a round filter element whose filter medium body 10 is configured as a filter bellows 10 and comprises a hollow cylindrical shape. The filter element 1 comprises a filter bellows 10 arranged around a longitudinal axis L and enclosing an interior 11. The filter bellows 10 has a first end face 101 and a second end face 102 arranged oppositely thereto. At the first end 101, an end disc 12 open toward the interior 11 is arranged, wherein an opening of the open end disc 12 is in fluid communication with the interior 11. At the second end 102, a further end disc 13 is arranged which for example may be a closed end disc 13. In the drawing figures, furthermore a radial direction R is indicated which, beginning at the longitudinal axis L, extends at a 90° angle outwardly.

The filter medium body 10 configured as a filter bellows 10 may permit flow therethrough along a flow direction D from the exterior to the interior in radial direction so that a clean side may be present in the interior 11. The filter medium body 10 has a circular cylindrical shape with an outer wall surface 103 at which an upstream side 105 may be present and with an inner wall surface 104 at which a downstream side 106 may be present. The filter element 1 however may also permit flow therethrough differently, e.g., from the interior to the exterior in radial direction, so that the upstream side 105 may be present at the inner wall surface 104.

At the end disc 12 open toward the interior 11, a seal device 14 is arranged which comprises at least one circumferentially extending sealing surface 141, 143. The circumferentially extending sealing surface 141, 143 has an undulated course which comprises a period and amplitude variable in circumferential direction.

The seal device 14 comprises a circumferential seal profile 142 which rises in direction of the longitudinal axis L from the end disc 12 open toward the interior 11 and comprises a circumferentially extending axial sealing surface 141 and/or a circumferentially extending radial sealing surface 143 at an inner circumference of the seal profile 142.

The circumferential seal profile 142 is for example one piece together with the end disc 12 open toward the interior 11. For example, the end disc 12 open toward the interior 11 is integrally formed together with the circumferential seal profile 142 at the filter medium body 10. In order to produce a fluid-tight and mechanically load-resistant connection to the filter medium body 10, the filter medium body 10 with its first end 101 is embedded in a material of the end disc 12, wherein the material of the end disc 12 penetrates along a predetermined penetration depth along the axial direction into the filter medium body 10.

The circumferentially extending sealing surface 141, 143 comprises about its entire circumference an undulated course, for example wherein the period and/or amplitude is variable across the entire circumference (see FIG. 4). The undulated course of the sealing surface 141, 143 has a transverse wave undulated and sine wave undulated course and/or one formed by a spline curve.

The filter medium body 10 has at the first end 101 an undulated course in relation to the axial direction which comprises a variable period and/or amplitude in circumferential direction. In other words, the height of the filter medium body 10 is variable across the circumference. The undulated course of the filter medium body 10 at the first end 101 corresponds to the undulated course of the circumferentially extending sealing surface 141, 143. The undulated course of the filter medium body 10 at the first end 101 is formed by axial cutting of the filter medium body 10. The end disc 12 open toward the interior 11 follows the three-dimensional contour of the filter medium body 10 provided by cutting at the first end 101, which contributes to a frugal material usage in producing the end disc 12.

The circumferentially extending sealing surface 141, 143 has a changing axial distance D_{Xi} in circumferential direction (see FIG. 2) in relation to a reference plane P_{R} extending in perpendicular direction in relation to the longitudinal axis L.

In relation to the longitudinal axis, the circumferentially extending sealing surface 141, 143 comprises a transverse wave undulated course whose “oscillation direction” extends in axial direction so that the circumferentially extending sealing surface 141, 143 has a changing axial position across the circumference.

At the inner wall surface 104 of the filter medium body 10, a fluid-permeable support grid 15 is arranged that is configured for example for supporting the filter medium body 10 against occurring differential pressures in case of a flow from the exterior to the interior in radial direction (clean side in the interior 11). At the first end 101, the fluid-permeable support grid 15 may be embedded with an end face section 151 (see FIG. 2) in a material of the open end disc 12, for example may be enclosed by a foamed plastic material of the open end disc 12.

In FIG. 2, a longitudinal section of the filter element of FIG. 1 is illustrated, wherein the section plane extends through a longitudinal center plane. The reference plane P_{R} extends in perpendicular direction to the longitudinal axis L and contains the first end 101 of the filter medium body 10 at a circumferential position which is sectioned at the left side in the illustration. The axial distance between the circumferentially extending sealing surface 141, for example axial sealing surface 141, and the reference plane P_{R} is indicated herein at a left side in the illustration by D_{X1} and at a right side in the illustration by D_{X2}. It is apparent that D_{X2}>D_{X1} because the distance D_{X1} varies across the circumference since the circumferentially extending sealing surface 141, 143 follows an (axial) wave shape. The reference plane P_{R} in principle may also be arranged at other positions, leading only to a different offset of the values of D_{X1} and D_{X2}.

Furthermore, the height of the filter medium body 10 at a left side in the illustration is identified by H_{B1} and at a right side in the illustration by H_{B2}. It is apparent that H_{B2}>H_{B1} because the distance H_{Bi} varies across the circumference since the first end 101 of the filter medium body, viewed across the circumference, comprises an undulated course which comprises a variable period and/or amplitude in circumferential direction and corresponds to the undulated course of the circumferentially extending sealing surface 141, 143. The heights H_{Bi} of the filter medium body 10 that change across the circumference may be produced for example by axial cutting of the filter medium body 10.

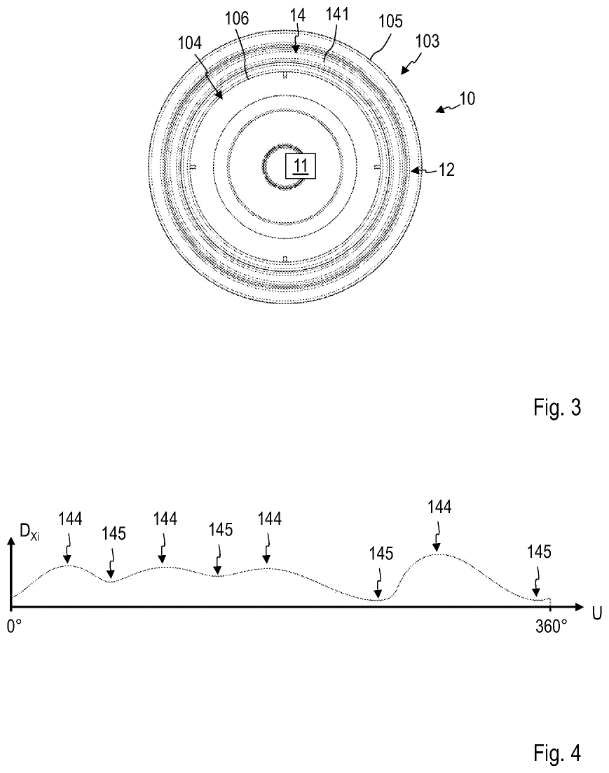

FIG. 3 shows a plan view of the filter element 1 of FIG. 1 from the side of the open end disc 12, wherein it is apparent that the seal device 14 with the circumferentially extending sealing surface(s) 141, 143 has a circular course in a projection along the longitudinal axis L. The wave shape of the circumferentially extending sealing surface(s) 141, 143 according to the first embodiment concerns exclusively the axial direction.

FIG. 4 shows a schematic illustration of an axial distance D_{Xi} of the circumferentially extending sealing surface in relation to the reference plane P_{R} across the circumference in a flattened view across the entire circumference of the seal device 14 (0° to 360°). The undulated course comprises, viewed across the circumference, a variable period as well as a variable amplitude and has four wave peaks 144 and four wave troughs 145 distributed across the circumference. In this way, a distinct rotation-asymmetrical structure results in relation to the longitudinal axis so that—with corresponding design of a housing sealing surface of the filter housing—a predetermined angular installation position may be reliably enforced.

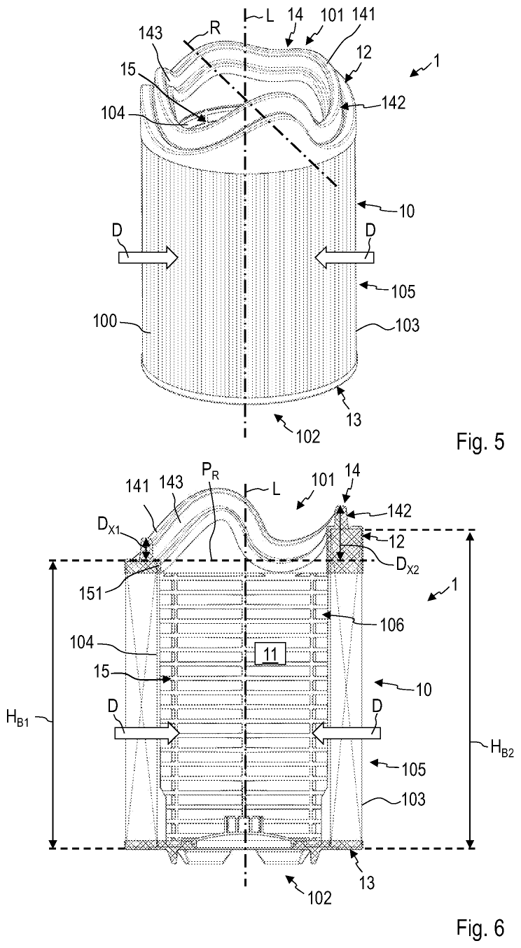

In FIG. 5 and FIG. 6, a second embodiment of the filter element 1 is illustrated. Since the filter element 1 according to the second embodiment is very similar to the filter element 1 of the first embodiment, only the differences will be explained in the following. Apart from that, features disclosed in relation to the first embodiment may be applied to the second embodiment, and vice versa.

The filter element 1 of the second embodiment differs in relation to the first embodiment only in that a material of the end disc 12 open toward the interior 11, viewed across the circumference, has a changing penetration depth into the filter medium body 10 along the axial direction L so that a penetration plane, facing the filter medium body 10 and defined by the end disc material penetrating into the filter medium body 10, is formed which extends in a perpendicular direction in relation to the longitudinal axis L and, for example, may coincide with a position of the reference plane P_{R}. A filter element 10 according to this second embodiment may be produced without problems by established production methods but has a higher material usage in regard to the end disc material.

In FIG. 5, folds 100 of the filter medium body 10 are additionally illustrated whose fold edges extend parallel to the longitudinal axis L. Radially outer fold edges define in this context the outer wall surface 103 while radially inner fold edges define the inner wall surface 104. The filter medium body 10 is for example a round filter bellows of the folded filter medium. This feature is explicitly not reserved for the second embodiment but may be combined at will with all further embodiments that concern round filter elements.

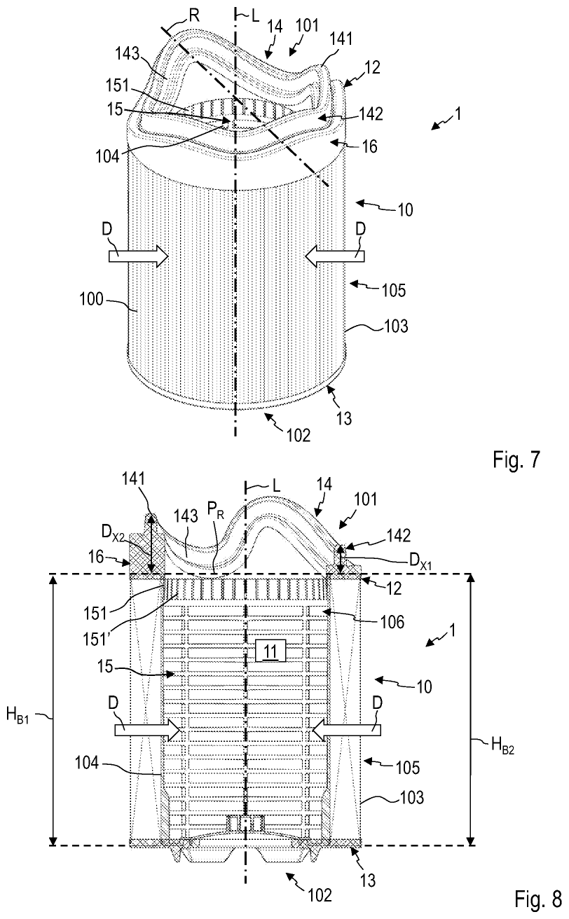

In FIG. 7 and FIG. 8, a third embodiment of the filter element 1 is illustrated. Since the filter element 1 according to the third embodiment is very similar to the filter element 1 of the second embodiment, only the differences will be explained in the following. Apart from that, features disclosed in relation to the first and/or second embodiment may be applied to the third embodiment, and vice versa.

The filter element 1 of the third embodiment differs from the second embodiment in that the first end 101 of the filter medium body 10 has no undulated course. Instead, the first end 101 of the filter medium body 10 lies in a plane, namely in a perpendicular plane in relation to the longitudinal axis L. A section, which extends completely around the circumference in axial direction between the first end 101 of the filter medium body 10 and the circumferentially extending sealing surface 141, 143 or the seal profile 142, is bridged in this context by a circumferentially extending flow guiding body 16. The flow guiding body 16 is for example connected directly to the first end 101 of the filter medium body 10.

The flow guiding body 16 is for example formed by a flow guiding section of the end disc 12 open toward the interior and is formed as one piece together with the end disc 12. In this way, a variable thickness of the end disc 12 across the circumference is provided which may be seen in FIG. 8 due to the significant difference between the end disc thicknesses at the left and right sides in the illustration. For example, the end disc 12 with integrated flow guiding section forming the flow guiding body 16 may comprise or be comprised of a foamed plastic material, for example a polyurethane foam. In relation to the radial direction, the flow guiding body 16 comprises a thickness which substantially corresponds to a fold height of a filter medium body 10 formed as a filter bellows 10.

A filter element 1 according to the third embodiment may be produced without cutting the filter medium body 10 at the first end 101, which reduces the production expenditure.

Furthermore, the support grid 15 in the region of the end face section 151 comprises a slit arrangement 151′ comprising a plurality of slits which are distributed across the circumference and for example extend parallel to the longitudinal axis L. The slits may extend substantially parallel to the longitudinal axis L. Due to the slit arrangement 151′, a formability of the filter element 1 in the region of the first end 101 is increased so that the latter may be elastically radially expanded with minimal forces, which may improve the sealing performance provided by the radial sealing surface 143.

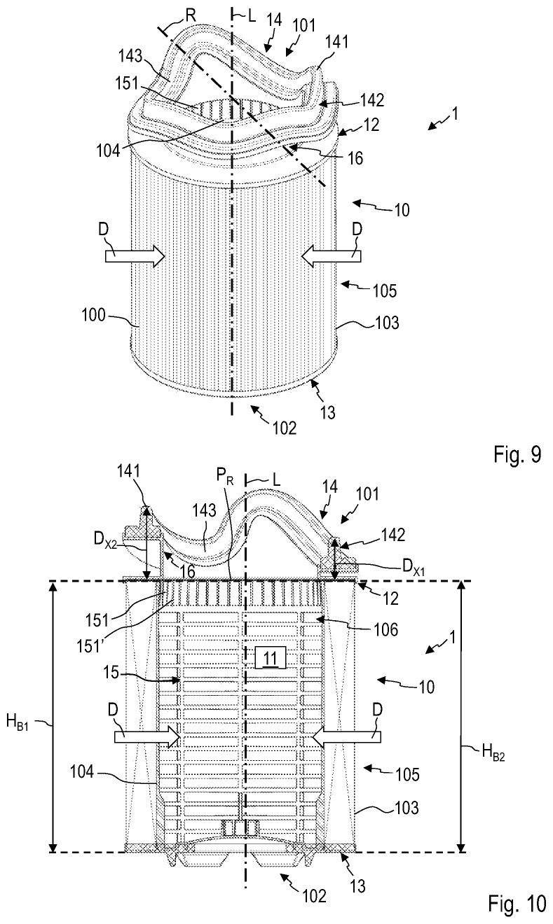

In FIG. 9 and FIG. 10, a fourth embodiment of the filter element 1 is illustrated. Since the filter element 1 according to the fourth embodiment is very similar to the filter element 1 of the third embodiment, only the differences will be explained in the following. Apart from that, features disclosed in relation to the first, second, and/or third embodiment may be applied to the fourth embodiment, and vice versa.

The filter element 1 of the fourth embodiment differs from the third embodiment in that the flow guiding body 16 is formed by a thin-walled plastic component. Thin-walled means for example that the flow guiding body 16, in relation to the radial direction, has a thickness which is a fraction of a fold height of a filter medium body 10 configured as a filter bellows 10. For example, a wall thickness of the flow guiding body 16 is smaller than ⅕, for example smaller than 1/10, of a fold height of a filter medium body 10 configured as a filter bellows 10. The flow guiding body 16 may be glued, for example, to the first end 101 of the filter medium body 10.

At its end which is facing the first end 101 of the filter medium body 10, the flow guiding body 16 comprises a radially projecting collar which forms the end disc 12 open toward the interior 11. At its end which is facing away from the first end 101 of the filter medium body 10, the flow guiding body 16 has a radially projecting flange at which the seal profile 142 with the circumferentially extending sealing surface(s) 141, 143 is arranged. The seal profile 142 is for example configured separate from the flow guiding body 16 and comprises a softer material than the flow guiding body 16. The flow guiding body 16 may for example comprise or be comprised of a hard plastic material, for example, polypropylene or a polyamide. The radially projecting flange comprises an undulated course with a variable period and/or amplitude in circumferential direction and corresponds to the undulated course of the circumferentially extending sealing surface(s) 141, 143 with variable period and/or amplitude in circumferential direction. The radially projecting flange of the flow guiding body 16 may have a groove-like cross section into which the seal profile 142 may be inserted as a separate part. The material usage in relation to the flow guiding body 16 is less in case of the filter element 1 according to the fourth embodiment than in the third embodiment. The flow guiding body 16 may be produced, for example, as an injection-molded part or blow-molded part.

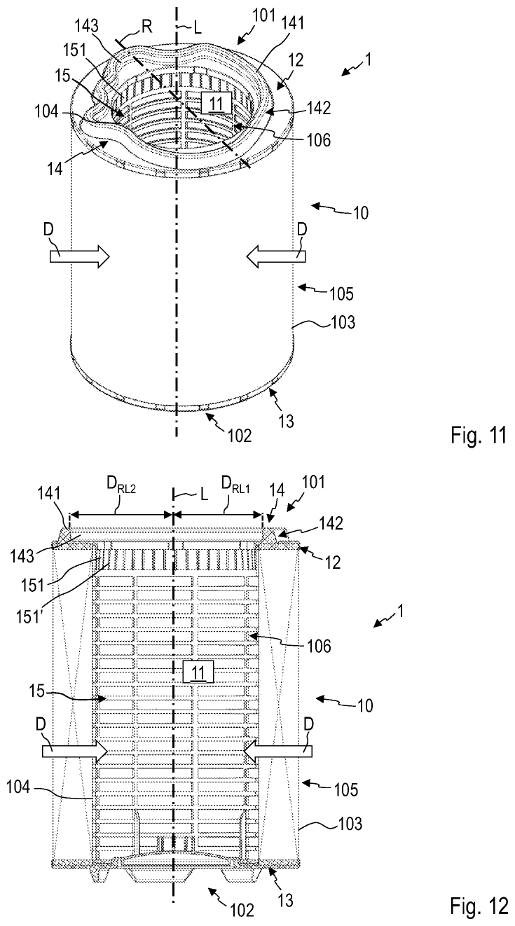

In FIG. 11 to FIG. 13, a fifth embodiment of the filter element 1 is illustrated which differs significantly from the embodiments of FIG. 1 through FIG. 10. Still, there are commonalities, for which reason in the following only the differences will be explained again. Apart from that, features disclosed in relation to the first, second, third, and fourth embodiment may be applied to the fifth embodiment, and vice versa.

The first end 101 of the filter medium body 10 lies in a plane, namely in a perpendicular plane in relation to the longitudinal axis L, in which also the end disc 12 open toward the interior 11 extends. The filter medium body 10 has for example a constant height across the circumference.

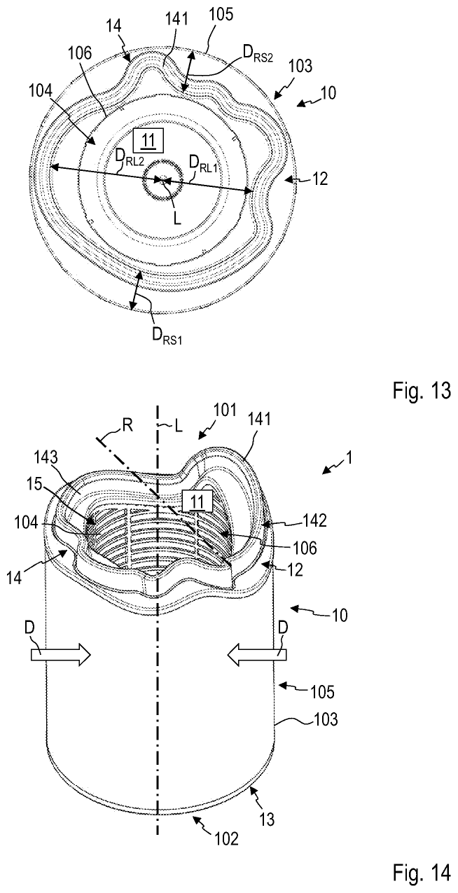

The circumferentially extending sealing surface(s) 141, 143 or the seal profile 142 has again an undulated course which comprises variable period and amplitude in circumferential direction. The circumferentially extending sealing surface(s) 141, 143 or the seal profile 142 comprises an undulated course across its entire circumference, for example wherein the period and/or amplitude is variable across the entire circumference (see FIG. 13). The undulated course of the sealing surface 141, 143 has a transverse wave undulated and sine wave undulated course and/or one formed by a spline curve.

The circumferentially extending sealing surface 141, 143 has a changing radial distance D_{RLi} in circumferential direction in relation to the longitudinal axis L (see FIG. 12).

In relation to the longitudinal axis L, the circumferentially extending sealing surface 141, 143 comprises a course configured to be transverse wave undulated whose “oscillation direction” extends in perpendicular direction so that the circumferentially extending sealing surface 141, 143 has a changing radial position across the circumference.

FIG. 12 shows a longitudinal section of the filter element of FIG. 11, wherein the section plane extends through a longitudinal center plane. The radial distance between the circumferentially extending sealing surface 141, 143, for example radial sealing surface 143, and the longitudinal axis L is identified herein by D_{RL2} at a left side in the illustration and by D_{RL1} at the right side in the illustration. It is apparent that D_{RL2}>D_{RL1} because the distance D_{RLi} varies across the circumference since the circumferentially extending sealing surface 141, 143 follows a (radial) wave shape.

This becomes even more clear in the plan view of FIG. 13. The undulated course of the circumferentially extending sealing surface(s) 141, 143 comprises, viewed across the circumference, a variable period as well as a variable amplitude, whereby a distinct rotation-asymmetrical structure results in relation to the longitudinal axis L.

Caused by the (radial) undulated course of the circumferentially extending sealing surface(s) 141, 143, a distance DRSi between a surface enveloping the filter medium body 10, for example a wall surface, and the circumferentially extending sealing surface(s) 141, 143 is variable across the circumference. This is illustrated in FIG. 13 by the two measurements D_{RS1} and D_{RS2}, wherein D_{RS1}<D_{RS2}.

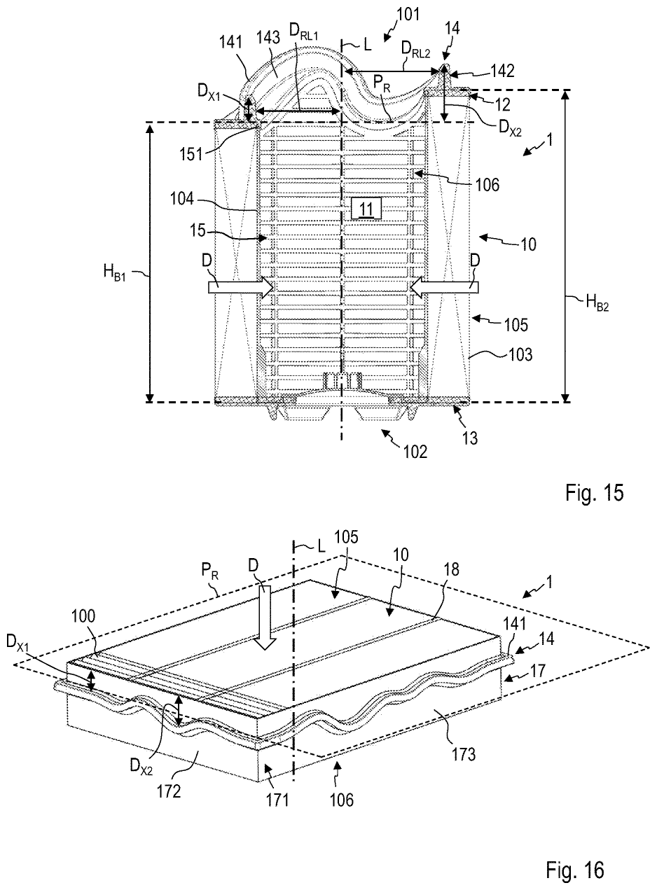

In FIG. 14 and FIG. 15, a sixth embodiment of the filter element is illustrated which represents a combination of the first embodiment (FIG. 1 to FIG. 4) with the fifth embodiment (FIG. 11 to FIG. 13). Apart from that, features disclosed in relation to the first, second, third, fourth, and fifth embodiment may be applied to the sixth embodiment, and vice versa.

The circumferentially extending sealing surface 141, 143 comprises across its entire circumference an undulated course, for example wherein the period and/or amplitude is variable across the entire circumference. The undulated course of the sealing surface 141, 143 has a transverse wave undulated and sine wave undulated course and/or one formed by a spline curve.

The filter medium body 10 has at the first end 101 an undulated course in relation to the axial direction which comprises a variable period and/or amplitude in circumferential direction. In other words, the height of the filter medium body 10 is variable across the circumference. The undulated course of the filter medium body 10 at the first end 101 corresponds to the undulated course of the circumferentially extending sealing surface 141, 143. The undulated course of the filter medium body 10 at the first end 101 is formed by axial cutting of the filter medium body 10. The end disc 12 open toward the interior 11 follows the three-dimensional contour of the filter medium body 10 at the first end 101 provided by cutting, which contributes to a frugal material usage in providing the end disc 12.

The circumferentially extending sealing surface 141, 143 has an axial distance D_{Xi} (see FIG. 15) variable in circumferential direction in relation to a reference plane P_{R} extending in perpendicular direction in relation to the longitudinal axis L.

In relation to the longitudinal axis, the circumferentially extending sealing surface 141, 143 has a course configured to be transverse wave undulated whose “oscillation direction” extends in axial direction so that the circumferentially extending sealing surface 141, 143 has a variable axial position across the circumference.

This becomes even more clear with the aid of FIG. 4 which shows a schematic illustration of an axial distance D_{Xi} of the circumferentially extending sealing surface in relation to the reference plane across the circumference in a flattened view across the entire circumference of the seal device 14 (0° to 360°). FIG. 4 shows in fact the flattened view for the filter element according to the first embodiment; however, this is identical to the flattened view of the filter element according to the sixth embodiment. The undulated course comprises, viewed across the circumference, a variable period as well as a variable amplitude and has, distributed across the circumference, four wave peaks 144 and four wave troughs 145.

Furthermore, the circumferentially extending sealing surface 141, 143 also has a radial distance D_{RLi} (see FIG. 15) in relation to the longitudinal axis L which changes in circumferential direction.

In relation to the longitudinal axis L, the circumferentially extending sealing surface 141, 143 comprises therefore in addition a course configured to be transverse wave undulated whose “oscillation direction” extends in perpendicular direction so that the circumferentially extending sealing surface 141, 143 has in addition a variable radial position across the circumference.

In FIG. 15, a longitudinal section of the filter element of FIG. 14 is illustrated, wherein the section plane extends through a longitudinal center plane. The reference plane P_{R} extends in perpendicular direction in relation to the longitudinal axis L and contains the first end 101 of the filter medium body 10 at a circumferential position which is sectioned at the left side in the illustration. The axial distance between the circumferentially extending sealing surface 141, for example axial sealing surface 141, and the reference plane P_{R} is identified here by D_{X1} at a left side in the illustration and by D_{X2} at a right side of the illustration. It is apparent that D_{X2}>D_{X1} because the distance D_{Xi} varies across the circumference since the circumferentially extending sealing surface 141, 143 follows an (axial) wave shape. The reference plane P_{R} may be arranged in principle also at other positions, leading only to a different offset of the values of D_{X1} and D_{X2}.

Furthermore, the height of the filter medium body 10 is identified by H_{B1} at a left side in the illustration and by H_{B2} at a right side in the illustration. It is apparent that H_{B2}>H_{B1} because the distance H_{Bi} varies across the circumference since the first end 101 of the filter medium body, viewed across the circumference, comprises an undulated course which comprises a variable period and/or amplitude in circumferential direction and corresponds to the undulated course of the circumferentially extending sealing surface 141, 143. The heights H_{Bi} of the filter medium body 10 changing across the circumference may be for example generated by an axial cutting of the filter medium body 10.

Moreover, the radial distance between the circumferentially extending sealing surface 141, 143, for example radial sealing surface 143, and the longitudinal axis L in this context is identified by D_{RL2} at a right side in the illustration and by D_{RL1} at a left side in the illustration. It is apparent that D_{RL2}>D_{RL1} because the distance D_{RLi} varies across the circumference since the circumferentially extending sealing surface 141, 143 follows a (radial) wave shape. This becomes even more clear in the plan view of FIG. 13 (plan view of the filter element according to the fifth embodiment which however is identical to a plan view of the filter element according to the sixth embodiment). The undulated course of the circumferentially extending sealing surface(s) 141, 143 comprises, viewed across the circumference, a variable period as well as a variable amplitude, whereby a maximally rotation-asymmetrical structure results in relation to the longitudinal axis L. As a result of the (radial) undulated course of the circumferentially extending sealing surface(s) 141, 143, a distance DRsi between a surface enveloping the filter medium body 10, for example a wall surface, and the circumferentially extending sealing surface(s) 141, 143 is variable across the circumference. This is illustrated in FIG. 13 by the two measurements D_{RS1} and D_{RS2} wherein D_{RS1}<D_{RS2}.

The filter element 1 of the sixth embodiment is thus characterized in that for the design of a sealing line, defined by the circumferentially extending sealing surface(s) 141, 143, degrees of freedom in axial direction as well as in radial direction are used in order to produce a maximally asymmetrical course of the sealing line. In addition to a forced angular orientation when installing the filter element in a corresponding filter housing, furthermore a very flexible adaptation to interference contours present in certain installation spaces is possible by these degrees of freedom when selecting the course of the sealing line.

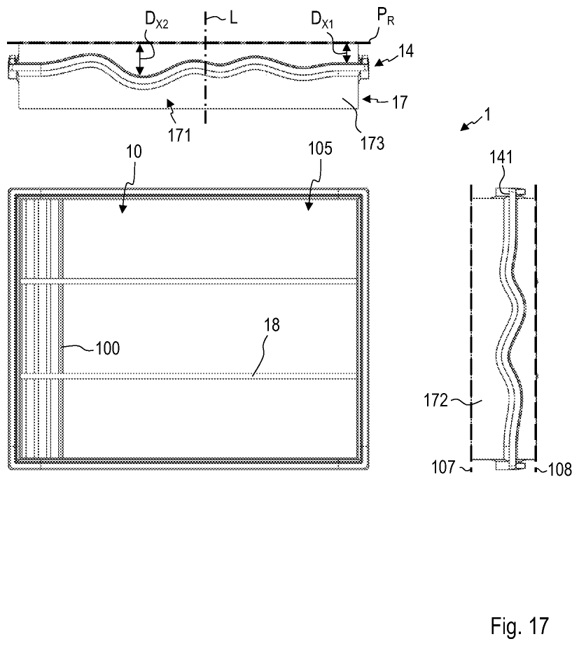

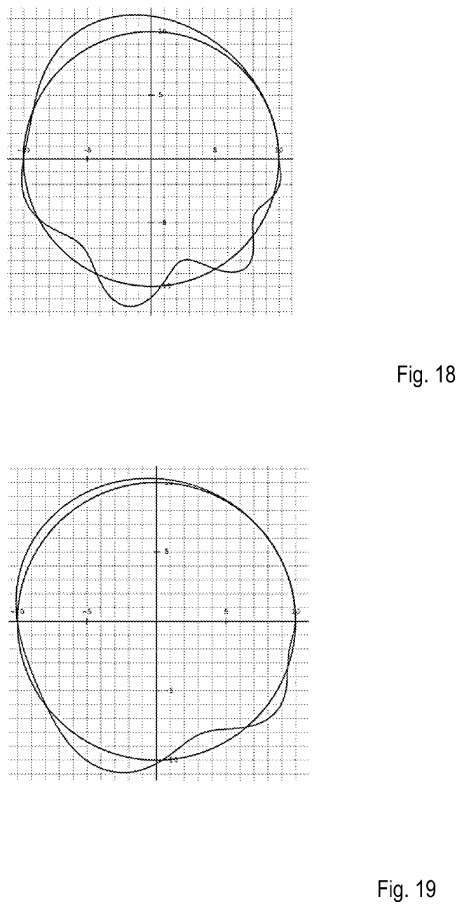

In FIG. 16 and FIG. 17, a filter element 1 according to a seventh embodiment is illustrated. In contrast to the filter elements according to the first to sixth embodiments (FIG. 1 to FIG. 15), the filter element 1 according to the seventh embodiment is a flat filter element. The filter element 1 comprises a filter medium body 10 configured as a flat filter bellows 10 of a filter medium with a plurality of folds 100. Inflow-side fold edges of the flat filter bellows 10 lie at the upstream side 105 in an inflow plane 107 and downstream fold edges at the downstream side 106 in an outflow plane 108. The upstream side 105 and the downstream side 106 are spaced apart from each other along the longitudinal axis L and the filter medium body 10 may permit flow therethrough along the longitudinal axis L. In principle, the flat filter bellows 10 however may also permit flow therethrough in reverse direction (arrow D toward the top).

A circumferential seal device 14 is arranged at an outer circumference of the filter medium body 10.

The filter medium body 10 is of a cuboid configuration and has four side faces. Two of the side faces, respectively, extend parallel to each other and lie opposite each other.

The filter element 1 comprises moreover a frame device 17 which frames the filter medium body 10 at its outer circumference, wherein the seal device 14 is arranged at a side face 171 of the frame device 17 which is facing away from the filter medium body 10. The seal device 14 protrudes radially past the frame device 17.

The frame device 17 may comprise or be comprised a plastic material which for example may be glued or molded onto the filter medium body. The frame device 17 however may also be formed of a textile material, for example, a spunbond nonwoven, and comprise a lateral band 173 at the end face edges of the flat filter bellows 10, respectively, as well as a head band 172 at the end folds of the flat filter bellows 10, respectively.

The seal device 14 comprises at least one circumferentially extending sealing surface 141 which may be an axial sealing surface. The circumferentially extending sealing surface 141 has a changing axial distance D_{Xi} in circumferential direction in relation to a reference plane P_{R} which extends in a perpendicular direction in relation to the longitudinal axis L. As illustrated in FIG. 16, the reference plane P_{R} coincides, for example, with the inflow plane 107. In case of the distances D_{X1} and D_{X2} shown as an example in FIG. 16 and FIG. 17, D_{X2}>D_{X1}.

In relation to the longitudinal axis, the circumferentially extending sealing surface 141 has a course configured to be transverse wave undulated whose “oscillation direction” extends in axial direction so that the circumferentially extending sealing surface 141 has a changing axial position across the circumference.

The circumferentially extending sealing surface 141 comprises in at least one partial region of the circumference an undulated course in which the period and/or amplitude is variable across the circumference. The undulated course of the circumferentially extending sealing surface 141 may be formed at least at one of the side faces of the flat filter bellows 10, for example at least at two side faces which for example may be positioned opposite each other.

The filter element 1 comprises in addition fold stabilization means 18 which support the folds 100 of the filter bellows 10 and maintain their shape which may be important for example in case of a sudden liquid load on a filter element 1 embodied as an air filter element. The fold stabilization means 18 may be, for example, threads or yarn glued to fold tips of the filter bellows 10.

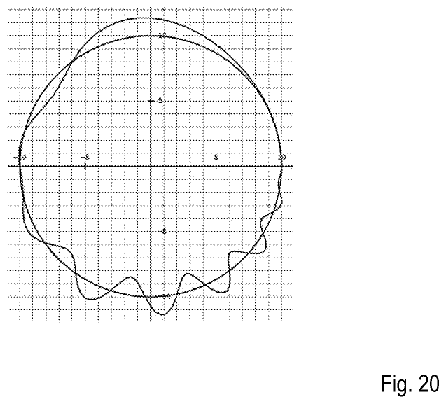

In FIG. 18 to FIG. 20, three possible undulated courses of the sealing surface of the seal device with a variable period and amplitude in circumferential direction are shown, wherein, in relation to the longitudinal axis L, the course comprises a course configured to be transverse wave undulated whose “oscillation direction” extends in perpendicular direction so that the course across the circumference has a changing radial distance in relation to a central longitudinal axis (center of the base circle).

The undulated course is illustrated, with a diameter of 20 units beginning at a base circle, wherein the base circle has been overlaid with a sine wave undulated course with a variable period and amplitude in circumferential direction which may be described by the following general functional equation:

f(x)=α·sin(b·x^{c})·D(x)
wherein
X is a circumferential coordinate,
a is a constant modifying the amplitude,
b is a constant modifying the period,
C is a constant modifying a variability of the period across the circumference, and
D(x) is a function of the circumferential coordinate, for example, a polynomial, a hyperbole function, a logarithm function, which modifies a variability of the amplitude across the circumference.

The exemplarily illustrated courses have been obtained by variation of the aforementioned parameters and demonstrate impressively that the undulated course of the sealing line may be adapted extremely flexibly to any technical boundary conditions.

Reference Characters

| | |
|---|---|
| 1 | filter element |
| 10 | filter medium body/filter bellows |
| 100 | folds |
| 101 | first end face |
| 102 | second end face |
| 103 | outer wall surface |
| 104 | inner wall surface |
| 105 | upstream side |
| 106 | downstream side |
| 107 | inflow plane |
| 108 | outflow plane |
| 11 | interior |
| 12 | end disc open toward the interior |
| 13 | further end disc, for example closed end disc |
| 14 | seal device |
| 141 | sealing surface |
| 142 | seal profile |
| 143 | radial sealing surface |
| 144 | wave peak |
| 145 | wave trough |
| 15 | support grid |
| 151 | end face section |
| 151′ | slit arrangement |
| 16 | flow guiding body |
| 17 | frame device |
| 171 | side face |
| 172 | head band |
| 173 | lateral band |
| 18 | fold stabilization means |
| L | longitudinal axis |
| R | radial direction |
| D | flow direction |
| D_{Xi} | axial distance |
| D_{RSi} | radial distance in relation to a surface |
| | enveloping the filter medium body |
| D_{RLi} | radial distance in relation to the longitudinal axis |
| P_{R} | reference plane |
| H_{Bi} | height of the filter medium body |

That which is claimed is:

1. A filter element for filtering a fluid, the filter element comprising:
at least one filter medium body comprising at least one filter medium, wherein the at least one filter medium body is configured to permit flow therethrough by a fluid to be purified in a flow direction from an upstream side to a downstream side;
at least one seal device arranged at the at least one filter medium body;
wherein the at least one seal device comprises at least one circumferentially extending sealing surface;
wherein the at least one circumferentially extending sealing surface comprises, in at least one circumferential section thereof, a first undulated course in a circumferential direction of the at least one circumferentially extending sealing surface;
wherein the first undulated course comprises one or more of a period variable in the circumferential direction and an amplitude variable in the circumferential direction.

2. The filter element according to claim 1, wherein the first undulated course extends across an entire circumference of the at least one circumferentially extending sealing surface and wherein the at least one of the period and the amplitude is variable across the entire circumference.

3. The filter element according to claim 1, wherein the first undulated course comprises one or more of a transverse wave undulated course, a sine wave undulated course, a rectangular wave undulated course, a triangular wave undulated course, a sawtooth wave undulated course, and a course formed by a spline curve.

4. The filter element according to claim 1, wherein the at least one filter medium body is arranged around a longitudinal axis and at least partially encloses an interior, wherein the at least one filter medium body is configured to permit flow therethrough in a radial direction in relation to the longitudinal axis.

5. The filter element according to claim 4, further comprising a first end disc open toward the interior and a second closed end disc, wherein the at least one filter medium body comprises a first end face and a second end face oppositely positioned to the first end face in an axial direction along the longitudinal axis, wherein the first end disc open toward the interior is arranged at the first end face of the at least one filter medium body and the second closed end disc is arranged at the second end face of the at least one filter medium body, and wherein the at least one seal device is arranged at the first end disc open toward the interior.

6. The filter element according to claim 5, wherein the at least one seal device comprises a circumferential seal profile rising in a direction of the longitudinal axis from the first end disc open toward the interior, wherein the circumferential seal profile comprises the at least one circumferentially extending sealing surface.

7. The filter element according to claim 6, wherein the circumferential seal profile and the first end disc open toward the interior together are one piece, and wherein the first end disc open toward the interior together with the circumferential seal profile is integrally formed at the at least one filter medium body.

8. The filter element according to claim 5, wherein the at least one filter medium body at the first end face comprises, in at least one circumferential section thereof, a second undulated course in the axial direction defined by the longitudinal axis, wherein the second undulated course comprises a period variable in the circumferential direction and/or an amplitude variable in the circumferential direction, wherein the second undulated course corresponds to the first undulated course of the at least one circumferentially extending sealing surface, and wherein the second undulated course of the at least one filter medium body is formed by axial cutting of the at least one filter medium body.

9. The filter element according to claim 5, wherein the first end face of the at least one filter medium body lies in a plane, wherein a section, extending at least partially circumferentially in the axial direction between the first end face of the at least one filter medium body and the at least one circumferentially extending sealing surface, is bridged by an at least partially circumferential flow guiding body connected indirectly or directly to the first end face of the at least one filter medium body.

10. The filter element according to claim 4, wherein the at least one filter medium body comprises a round filter bellows having a filter medium and further comprises folds, wherein the folds comprise radially outer fold edges lying in an outer wall surface of the at least one filter medium body and further comprise radially inner fold edges lying in an inner wall surface of the at least one filter medium body.

11. The filter element according to claim 4, wherein the at least one circumferentially extending sealing surface comprises at least one circumferential radial sealing surface at an inner circumference of a seal profile of the at least one seal device.

12. The filter element according to claim 1, wherein the upstream side and the downstream side of the at least one filter medium body are spaced apart from each other along a longitudinal axis of the at least one filter medium body, wherein the at least one filter medium body is configured to permit flow therethrough along the longitudinal axis, wherein the at least one seal device is arranged at or adjacent to an outer circumference of the at least one filter medium body.

13. The filter element according to claim 12, wherein the at least one filter medium body comprises a flat filter bellows comprised of a filter medium and further comprises folds, wherein the folds comprise inflow-side fold edges arranged in an inflow plane at the upstream side, and wherein the folds further comprises outflow-side fold edges arranged in an outflow plane at the downstream side.

14. The filter element according to claim 12, further comprising a frame device framing the at least one filter medium body at the outer circumference thereof at least partially circumferentially, wherein the at least one seal device is arranged at a side face of the frame device facing away from the at least one filter medium body, wherein the at least one seal device protrudes radially past the frame device.

15. The filter element according to claim 12, wherein the at least one seal device is arranged directly at the at least one filter medium body in a region of a circumferential outer edge of the at least one filter medium body at the upstream side or at the downstream side.

16. The filter element according to claim 1, wherein the at least one circumferentially extending sealing surface in the at least one circumferential section with the first undulated course comprises a changing axial distance in the circumferential direction in relation to a reference plane extending in a perpendicular direction in relation to a longitudinal axis of the at least one filter medium body.

17. The filter element according to claim 1, wherein the at least one circumferentially extending sealing surface in the at least one circumferential section with the first undulated course comprises a changing radial distance in the circumferential direction in relation to a surface enveloping the at least one filter medium body.

18. The filter element according to claim 1, wherein the at least one circumferentially extending sealing surface in the at least one circumferential section with the first undulated course comprises a changing radial distance in the circumferential direction in relation to a longitudinal axis of the at least one filter medium body.

19. The filter element according to claim 1, wherein the at least one seal device with the at least one circumferential section of the at least one circumferentially extending sealing surface with the first undulated course is rotation-asymmetrical.

20. The filter element according to claim 1, wherein the first undulated course of the at least one circumferentially extending sealing surface comprises at least two wave troughs and/or at least two wave peaks.
